(19) United States
(12) Patent Application Publication
(10) Pub. No.: US 2026/0261866 A1
(43) Pub. Date: Sep. 3, 2026

(54) MOVE LISTS FOR INTERFERENCE MANAGEMENT IN SHARED RADIO SPECTRUM

(71) Applicant: VIRGINIA TECH INTELLECTUAL PROPERTIES, INC., Blacksburg, VA (US)

(72) Inventors: Naru Jai, Blacksburg, VA (US); Yubo Wu; Yi Shi, Boyds, MD (US); Y. Thomas Hou, Blacksburg, VA (US)

(21) Appl. No.: 19/550,495

(22) Filed: Feb. 26, 2026

Related U.S. Application Data
(60) Provisional application No. 63/764,924, filed on Feb. 28, 2025.

(51) Int. Cl. H04W 16/14

(52) U.S. Cl. CPC H04W 16/14

(57) ABSTRACT

A spectrum access system (SAS) receives location data of citizens broadband radio service devices (CBSDs) and location data of dynamic protection area (DPA) protection points associated with a DPA. The SAS generates a plurality of revolving move lists (R-MLs) based on the location data. Each R-ML identifies a subset of the CBSDs that cease transmission when a radar system is active within the DPA. The R-MLs are generated to minimize overlap among the CBSDs across the R-MLs and minimize the average size of the R-MLs while maintaining aggregate interference at each DPA protection point below a regulatory interference threshold. The SAS monitors aggregate interference levels at the DPA protection points and compares the aggregate interference levels against the regulatory interference threshold. The SAS transmits transmission modification commands to the subset of the CBSDs identified in a selected R-ML responsive to detecting that the radar system is active within the DPA.

### CROSS-REFERENCE TO RELATED APPLICATIONS

This application claims the benefit of and priority to U.S. Provisional Patent Application No. 63/764,924, filed February 28, 2025, titled “MOVE LISTS FOR INTERFERENCE MANAGEMENT IN SHARED RADIO SPECTRUM,” the entire contents of which is hereby incorporated herein by reference.

### BACKGROUND

The deployment of next-generation wireless technologies requires access to broader spectrum channels to enable higher data throughput, lower latency, and enhanced network reliability. To address these evolving requirements, regulatory authorities have implemented spectrum-sharing frameworks that enable multiple classes of users to operate within shared frequency bands. In such frameworks, incumbent or high-priority users are typically granted primary spectrum access with interference protection measures, while secondary users may access the spectrum when doing so does not cause harmful interference to the incumbent users.

In dynamic spectrum-sharing environments, a spectrum management entity monitors, coordinates, and enforces spectrum access policies among different user classes. When an incumbent user becomes active within a protected geographic area, the spectrum manager may direct certain secondary users to cease transmission or modify their operating parameters to ensure that aggregate interference at the incumbent’s location remains below a regulatory threshold. The set of secondary users selected for transmission modification is commonly referred to as a move list.

Conventional approaches to move list generation typically produce a single, static move list that identifies the same subset of secondary users for deactivation each time the incumbent user becomes active. While such static move lists can satisfy interference protection requirements, static move lists may result in the same secondary users being repeatedly disrupted while other secondary users remain unaffected. Over time, this disparity can lead to inequitable service quality among secondary users operating in proximity to protected areas.

### SUMMARY

In various implementations, a spectrum access system (SAS) can receive location data of a plurality of citizens broadband radio service devices (CBSDs) and location data of a plurality of dynamic protection area (DPA) protection points associated with a DPA. The SAS can generate a plurality of revolving move lists (R-MLs) based on the location data. Each R-ML can identify a subset of the CBSDs that cease transmission when a radar system is active within the DPA. The plurality of R-MLs can be generated to minimize overlap among the plurality of CBSDs across the plurality of R-MLs while maintaining aggregate interference at each DPA protection point of the plurality of DPA protection points below a regulatory interference threshold.

The SAS can aggregate interference levels at each DPA protection point of the plurality of DPA protection points and compares the aggregate interference levels against the regulatory interference threshold. The SAS can transmit transmission modification commands to the subset of the CBSDs identified in a selected R-ML responsive to detecting that the radar system is active within the DPA.

In some implementations, the plurality of R-MLs can be further generated to minimize an average number of CBSDs per R-ML. The SAS may select the subset of the CBSDs for inclusion in each R-ML based on signal propagation characteristics between each CBSD of the plurality of CBSDs and the plurality of DPA protection points.

In some implementations, the SAS can apply different R-MLs from the plurality of R-MLs across successive activations of the radar system. The SAS may generate a must move list (M-ML) identifying a second subset of the plurality of CBSDs that cease transmission during every activation of the radar system, wherein each CBSD of the second subset individually produces interference at one or more DPA protection points of the plurality of DPA protection points exceeding the regulatory interference threshold.

In some implementations, the SAS can evaluate aggregate interference at each DPA protection point of the plurality of DPA protection points across a plurality of beam directions associated with a directional radar beam emitted by the radar system. The SAS may verify that the aggregate interference levels at the plurality of DPA protection points remain below the regulatory interference threshold following transmission of the transmission modification commands.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A depicts a dynamic protection area (DPA) and citizens broadband radio service devices (CBSDs) according to various implementations of the present disclosure.

FIG. 1B depicts radar beam characteristics associated with a radar system operating within a DPA according to various implementations of the present disclosure.

FIG. 2A depicts a layout of a DPA illustrating categorization of CBSDs using a static move list (S-ML).

FIG. 2B depicts a layout of a DPA illustrating categorization of CBSDs using a first revolving move list (R-ML) according to various implementations of the present disclosure.

FIG. 2C depicts a layout of a DPA illustrating categorization of CBSDs using a second R-ML according to various implementations of the present disclosure.

FIG. 3 depicts an aggregate interference chart illustrating interference levels at DPA protection points according to various implementations of the present disclosure

FIG. 4 depicts a block diagram of an operating environment according to various implementations of the present disclosure.

FIG. 5 depicts a flowchart of a method for managing interference within a DPA using R-MLs according to various implementations of the present disclosure.

FIG. 6 depicts a flowchart of a method for computing R-MLs according to various implementations of the present disclosure.

FIG. 7 depicts a flowchart of a method for interference monitoring according to various implementations of the present disclosure.

### DETAILED DESCRIPTION

The present disclosure pertains to multiple move lists including secondary users to mitigate interference to primary users during their active operational periods. A move list is defined as a subset of secondary users required to cease transmission on the primary users' operating channel to ensure that the aggregate interference from the remaining secondary users is below a specified threshold. Traditional fixed move lists repeatedly deactivate the same subset of secondary users, leading to fairness issues due to repeated disruptions for certain users while others remain unaffected. The disclosed method is designed to generate multiple move lists with the objectives of minimizing the overlap among the move lists and concurrently minimizing the average size of each move list. This disclosure offers spectrum managers flexibility to balance fairness and efficiency, reducing service disruptions for secondary users, improving spectrum efficiency, and enhancing coexistence between secondary and primary users. In certain implementations, similar mathematical models are employed to address the variation of the problem, while preserving the core principles of the disclosed methodology.

The deployment of next-generation wireless technologies requires access to broader spectrum channels to enable higher data throughput, lower latency, and enhanced network reliability. To address these evolving requirements, regulatory authorities, such as the Federal Communications Commission (FCC), are implementing strategies for spectrum optimization, including the repurposing of existing frequency bands and the development of spectrum-sharing frameworks. Notable examples of such spectrum-sharing implementations include the Citizens Broadband Radio Service (CBRS) band, the 6 gigahertz (GHz) band, and various other frequency allocations, where incumbent or high-priority users are granted primary spectrum access with stringent interference protection measures from secondary users.

In dynamic spectrum-sharing environments, a structured framework is required to ensure that lower-tier or secondary users operate without causing harmful interference to higher-tier or incumbent users. This framework typically involves a spectrum management entity, which monitors, coordinates, and enforces spectrum access policies among different user classes. The spectrum manager may implement access prioritization, interference mitigation strategies, and real-time spectrum allocation mechanisms to optimize the coexistence of multiple users within a shared band.

The following description focuses on an example implementation using the Citizens Broadband Radio Service (CBRS) in the 3.5 GHz band. However, the concepts and technologies described herein are broadly applicable to other frequency bands. Within the CBRS context, the Spectrum Access System (SAS) functions as the spectrum manager, responsible for enforcing spectrum access policies and managing interference protection. The Navy radars operate as incumbent users, whose operations are protected within Dynamic Protection Areas (DPAs), which are large geographic regions where incumbent activity may occur. Within each DPA, specific protection points are assumed as incumbent locations, where the SAS actively enforces interference protection. The Priority Access License (PAL) users and General Authorized Access (GAA) CBRS Devices (CBSDs) function as secondary users, operating under spectrum-sharing constraints that ensure compliance with interference protection requirements. Throughout this disclosure, the terms spectrum manager, incumbent users, and secondary users serve as generalized equivalents of SAS, Navy radars, and PAL/GAA CBSDs (users), respectively. These broader terms highlight the flexibility and applicability of the proposed framework, demonstrating its adaptability across various spectrum-sharing environments beyond CBRS.

The CBRS band, spanning 3550–3700 megahertz (MHz), operates under a three-tier spectrum-sharing framework established by the Federal Communications Commission (FCC). The three tiers consist of incumbent users, PAL holders, and GAA users, each with defined access and protection rights. The incumbent users receive priority access and protection; PAL holders, who are granted defined access rights within specified geographies; and GAA users, who may access available spectrum on a best effort basis when not interfering with the higher-tier users.

The highest tier or incumbent users predominantly consists of U.S. Navy shipborne radars. These radars employ highly directional beams to perform essential defense operations, requiring robust protection from interference across their operating range. To ensure interference protection without disclosing the Navy radar’s precise location, National Telecommunications and Information Administration (NTIA) established DPAs to dynamically safeguard incumbents from interference caused by lower-tier users.

PAL holders occupy the second tier and are licensed users with exclusive rights to specific 10 MHz channels (up to 40 MHz in total) within defined geographic areas within the frequency range 3550 MHz to 3650 MHz. These licenses are awarded through FCC auctions and are typically utilized by businesses and service providers requiring predictable, interference-protected access to the spectrum. PAL users are protected from interference caused by GAA users and other PAL users.

GAA users represent the third tier, operating on a non-exclusive, best-effort basis. GAA users access the spectrum opportunistically, utilizing any frequencies not actively occupied by incumbent or PAL users. While GAA users benefit from access to the spectrum, GAA users are not afforded protection from interference by the higher tiers or other GAA users.

To protect incumbent operations, the NTIA established DPAs along U.S. coastlines, dynamically activating the DPAs when Navy radar systems are in use. Upon activation of a DPA, aggregate interference from neighboring CBSDs must remain below strict thresholds across all the DPA protection points and all potential radar beam directions. To manage this, spectrum access systems (SASs) precompute a move list of CBSDs required to cease transmission when the DPA is activated. These lists are generated based on path loss calculations and interference evaluations for each CBSD relative to the DPA points and beams.

Some approaches rely on a static move list for each DPA, which mandates the same subset of CBSDs to shut down during every activation. While effective in maintaining interference thresholds, such static approaches may raise fairness concerns as the same CBSDs consistently bear the burden of shutdowns. Efforts to optimize move list sizes have been proposed, but the fairness issue inherent in static methodologies remains unaddressed.

The present disclosure describes revolving move lists (R-MLs) as a dynamic approach to manage interference during DPA activations. Unlike static move list methodologies, which repeatedly shut down the same subset of CBSDs, the systems and methods described herein employ multiple precomputed move lists that may be utilized in a circular sequence. The R-MLs are optimized to minimize overlap of CBSDs across lists as well as the average size of each move list while maintaining compliance with interference thresholds

The present disclosure improves upon static move lists by addressing fairness concerns and distributing shutdown obligations across multiple move lists, thereby ensuring a more equitable spectrum management process. A multi-objective optimization framework is employed to determine R-MLs, reducing redundancy between lists while keeping the average size of each move list as small as possible. Through this approach, the present disclosure ensures compliance with interference protection requirements while alleviating the operational burden on specific CBSDs.

The present disclosure provides significant advantages over existing methods of interference management in the CBRS band. Enhanced fairness is achieved by distributing shutdown obligations across multiple CBSDs through the use of R-MLs. This approach ensures that no single set of devices is repeatedly burdened with operational interruptions, addressing critical limitations of static move list methodology and fostering a more equitable spectrum-sharing environment.

R-MLs provide improved resource utilization by optimizing the composition of move lists to minimize their overlap while keeping their size small. This ensures that fewer CBSDs are shut down overall, preserving operational capabilities for as many devices as possible and maximizing the efficiency of spectrum usage while still meeting interference protection requirements.

The present disclosure describes systems and methods for sustained compliance with regulatory interference limits by maintaining robust protection for incumbent users, such as Navy radars, through precomputed move lists that adhere to interference thresholds. The optimization framework balances competing objectives, such as minimizing overlap and average list size, while maintaining adherence to interference standards across potential beam directions and DPA protection points. This capability provides a dynamic, fair, and efficient spectrum management approach that aligns with the evolving demands of shared spectrum environments while maintaining regulatory and operational integrity.

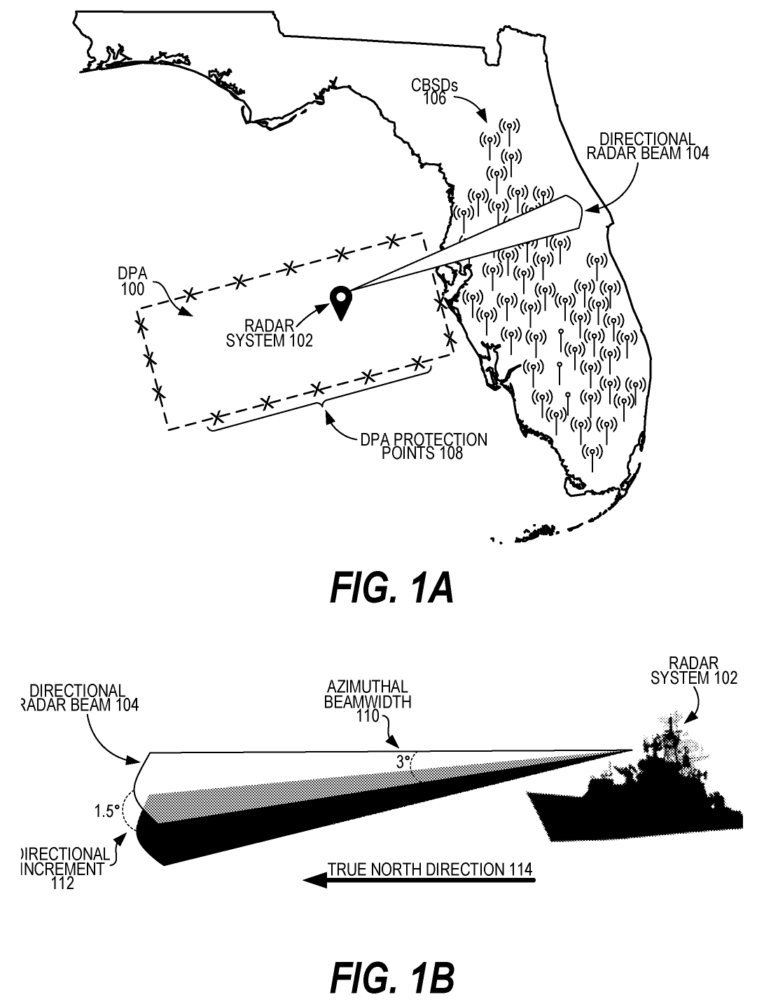

Turning to FIG. 1A, shown is a dynamic protection area (DPA) 100 according to an example implementation. The DPA 100 is a geographically defined region where interference protection measures are enforced to protect incumbent operations, such as federal radar systems, from interference caused by secondary spectrum users. In the illustrated example, the DPA 100 is located along the Florida coastline, though DPAs may be established in other geographic regions.

A radar system 102 operates within the DPA 100 as an incumbent system requiring interference protection. The radar system 102 emits a directional radar beam 104, which may have a defined beamwidth and may rotate across an azimuth range during operation. In some implementations, the radar system 102 is a shipborne Navy radar.

Citizens broadband radio service devices (CBSDs) 106 operate in proximity to the DPA 100. The CBSDs 106 may include Category A and Category B CBSDs, each having different effective isotropic radiated power (EIRP) limits. When the DPA 100 is activated, certain CBSDs 106 may be required to cease transmission or modify transmission parameters to maintain compliance with a regulatory interference threshold.

To preserve the confidentiality of the radar’s location (e.g., a shipborne Navy radar), DPA protection points 108 are strategically defined. The DPA 100 includes a plurality of DPA protection points 108, which are designated locations where aggregate interference levels from the CBSDs 106 are evaluated. In the illustrated implementation, the DPA protection points 108 are positioned along the boundary of the DPA 100. In other implementations, the DPA protection points 108 may be located at other positions within or along the perimeter of the DPA 100. The DPA protection points 108 may be spaced at regular intervals, such as approximately 30 kilometers apart, though other spacing configurations are possible.

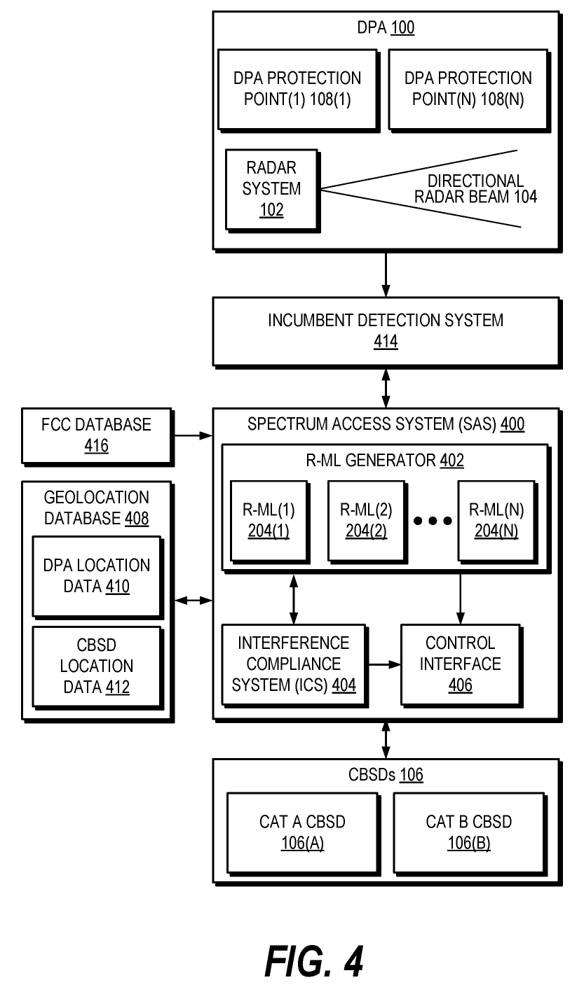

The CBSDs 106 located within the neighborhood of the DPA 100 are subject to transmission modification based on move list assignments. To mitigate interference, a spectrum access system (SAS), such as the SAS 400 described with reference to FIG. 4, precomputes move lists that identify which CBSDs 106 should cease operation or modify transmission parameters when the DPA 100 is activated. These move lists may include a must move list (M-ML), which includes a subset of CBSDs 106 that should be shut down due to their high interference contribution, and revolving move lists (R-MLs), which dynamically rotate shutdown responsibilities among different subsets of CBSDs 106 across successive DPA activations.

A regulatory interference threshold, such as -144 dBm per 10 MHz, defines the maximum allowable aggregate interference level at each DPA protection point 108 across all beam directions. If the aggregate interference from the CBSDs 106 exceeds this threshold at any DPA protection point 108 for any beam direction, corrective measures can be initiated by transmitting transmission modification commands to the CBSDs 106 in accordance with the precomputed move lists.

Turning to FIG. 1B, shown is a visual representation of the radar beam characteristics associated with the radar system 102 operating within the DPA 100 according to an example implementation. The radar system 102, depicted as a shipborne Navy radar, emits the directional radar beam 104 that may rotate across an azimuth range. In the illustrated example, the directional radar beam 104 has an azimuthal beamwidth 110 of approximately 3 degrees. At any given moment, the radar system 102 scans a sector corresponding to the azimuthal beamwidth 110 before progressing to the next segment in its rotation.

The radar system 102 may operate in a continuous scanning mode, systematically rotating to cover an entire azimuth range while maintaining a consistent beamwidth. For aggregate interference calculations, interference may be evaluated at discrete directional increments 112 rather than at an infinite number of directions within the azimuth range. In the illustrated example, the directional increments 112 are approximately 1.5 degrees, resulting in 240 discrete beam directions for a full 360-degree azimuth range. This overlapping evaluation approach, where the directional increment 112 is smaller than the azimuthal beamwidth 110, ensures full coverage of all potential beam orientations.

A true north direction 114 provides a reference for the scanning orientation of the radar system 102. As the directional radar beam 104 moves through successive azimuth angles, different CBSDs 106 near the DPA 100 may fall within its interference-sensitive region.

The beam characteristics shown in FIG. 1B are used for estimating aggregate interference at each DPA protection point 108. Since the directional radar beam 104 may continuously rotate, interference impact assessments consider all azimuth directions of the directional radar beam 104. Knowledge of the azimuthal beamwidth 110, the directional increments 112, and the scanning cycle may be used to precompute move lists. This ensures that the aggregate interference from remaining active CBSDs 106 does not exceed the regulatory interference threshold for any beam orientation at any DPA protection point 108.

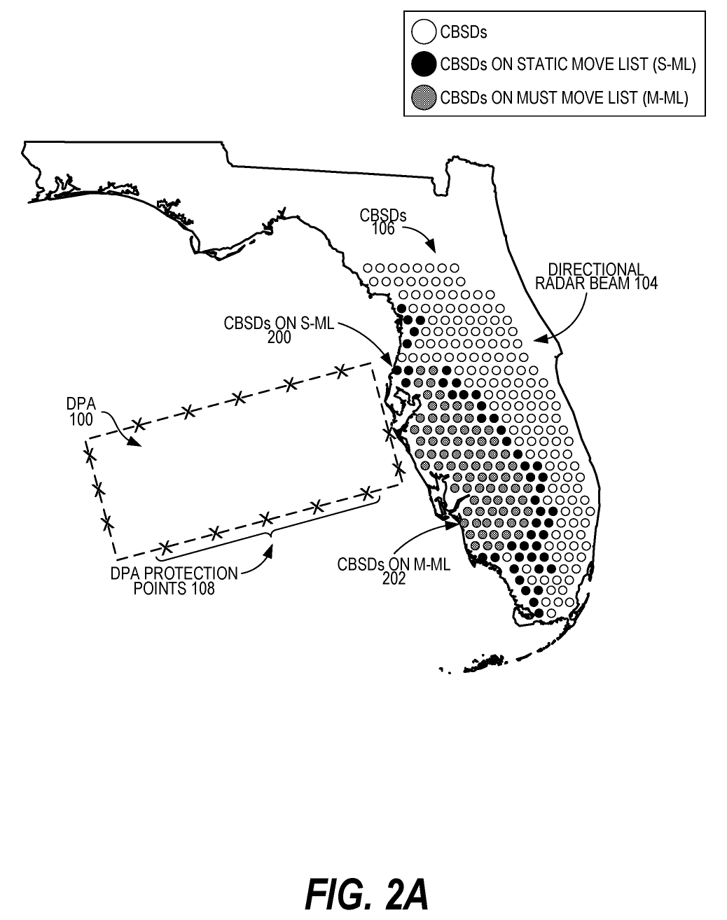

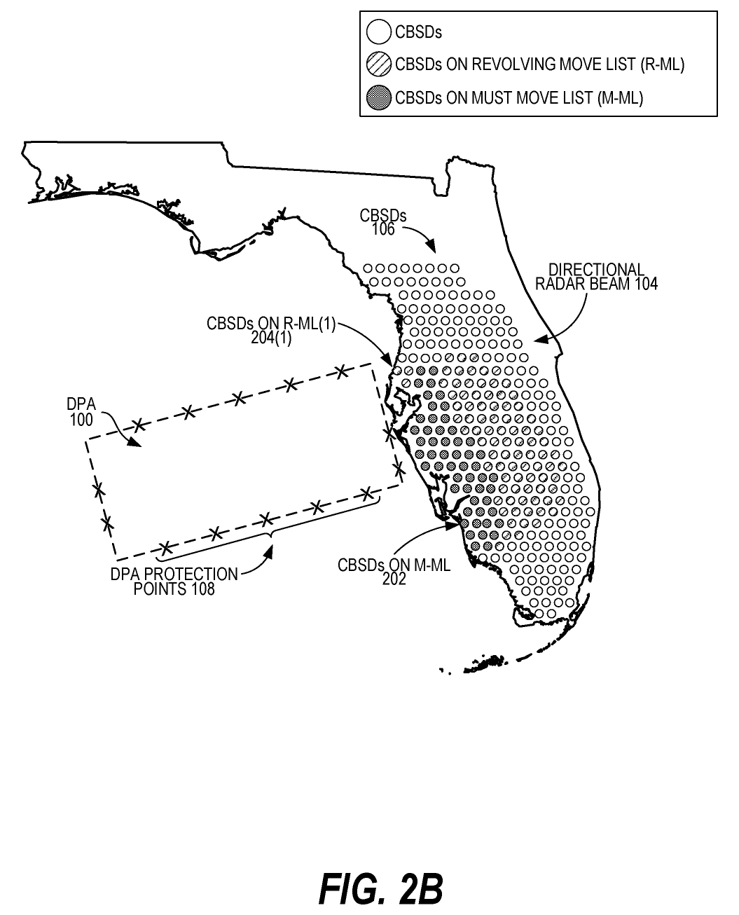

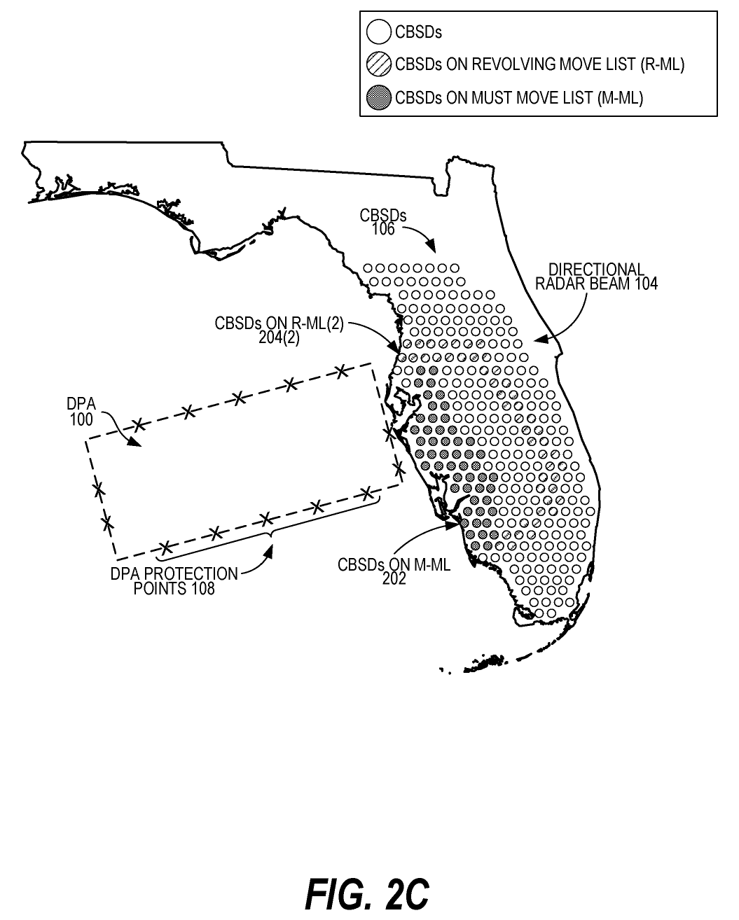

Turning to FIG. 2A, shown is the DPA 100 with the distribution of CBSDs 106 near the DPA 100 according to a static move list approach. The DPA protection points 108, represented by “X” markers, are positioned along the boundary of the DPA 100. The directional radar beam 104 is emanating from each of the DPA protection points 108, although the directional radar beam 104 is not shown in this example so as not to obscure the distribution of CBSDs 106.

FIG. 2A illustrates a static move list (S-ML) approach, where a single precomputed move list is applied each time the DPA 100 is activated. In this approach, the CBSDs 106 are categorized into three groups: active CBSDs 106 (shown as open circles), which remain operational when the DPA 100 is activated; CBSDs on an S-ML 200 (shown as solid black circles), which are shut down each time the DPA 100 is activated to maintain interference compliance; and CBSDs on a must move list (M-ML) 202 (shown as dotted circles), which are shut down during every DPA activation because each CBSD on the M-ML 202, even when operating in isolation, produces interference at one or more DPA protection points 108 exceeding the regulatory interference threshold.

The S-ML 200 includes CBSDs 106 that are selected by an algorithm to ensure that the aggregate interference from the remaining active CBSDs 106 remains below the regulatory interference threshold at each DPA protection point 108 across all beam directions. The final move list applied during a DPA activation is the union of the CBSDs 106 on the M-ML 202 and the CBSDs 106 on the S-ML 200.

While effective at ensuring threshold compliance, this static approach may raise fairness concerns because the same CBSDs 106, particularly those on the S-ML 200, are repeatedly shut down during each DPA activation, disproportionately impacting their ability to access spectrum.

Turning to FIG. 2B, shown is the DPA 100 with the distribution of CBSDs 106 according to a first revolving move list (R-ML) 204(1), which provides an alternative to the S-ML approach shown in FIG. 2A. Instead of using a fixed S-ML 200 for every DPA activation, the R-ML methodology implements multiple move lists that may be applied in a rotating sequence to distribute shutdown responsibilities more equitably among the CBSDs 106.

In FIG. 2B, the CBSDs 106 are categorized into three groups: active CBSDs 106 (shown as open circles), which remain operational when the DPA 100 is activated; CBSDs on the first R-ML 204(1) (shown as hatched circles), which are shut down when the first R-ML 204(1) is the active move list; and CBSDs on the M-ML 202 (shown as dotted circles), which are shut down during every DPA activation.

The M-ML 202 remains unchanged from the S-ML approach shown in FIG. 2A. The CBSDs 106 on the M-ML 202 are shut down during every DPA activation because each individually exceeds the regulatory interference threshold. However, instead of using the S-ML 200, the first R-ML 204(1) selects a different subset of CBSDs 106 for shutdown. When combined with the M-ML 202, the first R-ML 204(1) ensures that aggregate interference remains below the regulatory interference threshold at each DPA protection point 108 across all beam directions.

Turning to FIG. 2C, shown is the DPA 100 with the distribution of CBSDs 106 according to a second R-ML 204(2), which illustrates how shutdown responsibilities rotate among CBSDs 106 across successive DPA activations. As with FIG. 2B, the M-ML 202 remains unchanged, and the same CBSDs 106 on the M-ML 202 are shut down each time the DPA 100 is activated. However, in FIG. 2C, a different subset of CBSDs 106 is included in the second R-ML 204(2) (shown as hatched circles) compared to the first R-ML 204(1) shown in FIG. 2B.

The R-MLs 204(1), 204(2) are computed to minimize the overlap of CBSDs 106 across the move lists while also minimizing the average size of each move list. In some implementations, only a small number of CBSDs 106 appear on both the first R-ML 204(1) and the second R-ML 204(2). Across successive DPA activations, the shutdown responsibilities are distributed among different CBSDs 106, reducing the repeated burden on individual devices.

In operation, when the DPA 100 is activated for a first time, the SAS 400 may apply the first R-ML 204(1) to determine which CBSDs 106 should cease transmission. When the DPA 100 is activated for a subsequent time, the SAS 400 may apply the second R-ML 204(2) instead, and so on. This rotating application of R-MLs may continue in a circular sequence, cycling back to the first R-ML 204(1) after all R-MLs have been applied.

A trade-off of the R-ML approach is that the average size of each R-ML may be slightly larger than the S-ML 200, resulting in more CBSDs 106 being shut down during any single DPA activation. However, fewer CBSDs 106 are repeatedly impacted over time across multiple DPA activations, providing a more equitable distribution of shutdown responsibilities while maintaining compliance with the regulatory interference threshold.

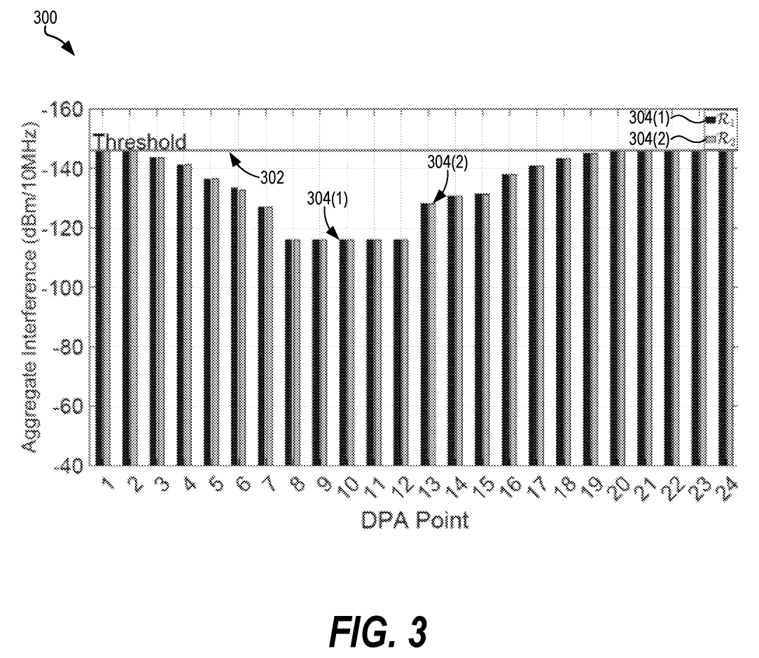

Turning to FIG. 3, shown is an aggregate interference chart 300 illustrating interference levels at the DPA protection points 108 for a configuration using a selected Pareto-optimal solution for two R-MLs according to an example implementation. The aggregate interference chart 300 provides example validation that the R-ML methodology satisfies interference protection requirements.

The y-axis of the aggregate interference chart 300 represents the aggregate interference levels in dBm/10MHz, while the x-axis represents the individual DPA protection points 108 within the DPA 100. In the illustrated example, interference levels are shown for twenty-four DPA protection points 108, though other implementations may include a different number of DPA protection points 108.

A regulatory interference threshold 302 is depicted as a horizontal line at -144 dBm/10MHz, representing a maximum allowable aggregate interference level at each DPA protection point 108. The regulatory interference threshold 302 ensures that incumbent operations, such as Navy radar systems, remain protected from harmful interference. Additional or alternative thresholds may be used for different incumbent operations.

The aggregate interference chart 300 depicts R-ML interference levels 304(1), 304(2) for the first R-ML 204(1) and the second R-ML 204(2), respectively. The R-ML interference levels 304(1) for the first R-ML 204(1) are shown as dark bars, and the R-ML interference levels 304(2) for the second R-ML 204(2) are shown as light bars. For each DPA protection point 108, the depicted interference level represents the strongest aggregate interference observed across all beam directions when the respective R-ML is applied.

As shown in FIG. 3, the R-ML interference levels 304(1), 304(2) at all DPA protection points 108 remain below the regulatory interference threshold 302, confirming that both the first R-ML 204(1) and the second R-ML 204(2) satisfy interference protection requirements. This validation demonstrates that the R-ML methodology maintains compliance with regulatory interference limits while distributing shutdown responsibilities across multiple move lists.

Turning to FIG. 4, shown is an operating environment in which aspects of the present disclosure can be implemented according to an illustrative example. The operating environment facilitates managing interference protection within the DPA 100 by implementing an R-ML methodology to ensure compliance with regulatory interference thresholds while optimizing CBSD spectrum utilization. The DPA 100 represents the geographically defined protected region and is designed to safeguard incumbent systems, such as the radar system 102, from interference caused by CBSDs 106.

The DPA 100 includes multiple DPA protection points 108(1)-108(N), where aggregate interference levels are monitored to enforce regulatory compliance. The DPA protection points 108 serve as measurement locations for interference evaluation, as described above with reference to FIGS. 1A-1B and validated in FIG. 3. The radar system 102 operates at each of the DPA protection points 108, emitting the directional radar beam 104 with the azimuthal beamwidth 110, scanning across an azimuth range to conduct surveillance. The beam characteristics influence the interference sensitivity thresholds, which in turn determine the composition of move lists (e.g., the M-ML 202, the S-ML 200, and the R-MLs 204(1), 204(2)).

A spectrum access system (SAS) 400 is a management entity responsible for overseeing the operation of the CBSDs 106 in compliance with regulatory interference protection requirements. The SAS 400 allocates spectrum resources to the CBSDs 106 while ensuring regulatory compliance. The SAS 400 may be implemented using one or more computing devices, each including one or more processors and memory storing instructions that, when executed by the one or more processors, cause the SAS 400 to perform the operations described herein. To achieve real-time spectrum coordination and interference mitigation, the SAS 400 integrates multiple subsystems, including an R-ML generator 402, an interference compliance system (ICS) 404, a control interface 406, and a geolocation database 408.

The R-ML generator 402 dynamically manages spectrum access and mitigates interference by generating and maintaining multiple R-MLs 204, such as the R-MLs 204(1), 204(2) discussed above. Unlike the S-ML 200, which mandates the same CBSDs 106 to shut down upon each DPA activation, the R-ML generator 402 distributes shutdown responsibilities among CBSDs 106 across multiple activation events, improving fairness while maintaining regulatory compliance.

The R-ML generator 402 may employ an optimization algorithm, such as a multi-objective optimization algorithm, to compute and update multiple R-MLs 204. The optimization algorithm may be designed to minimize the overlap of the CBSDs 106 across different R-MLs 204 and minimize the average size of each R-ML 204. In this manner, the optimization algorithm can ensure that no single CBSD 106 is consistently turned off when the DPA 100 is activated. The R-ML methodology disclosed herein may reduce the number of CBSDs 106 that are shut down in successive activations to achieve a reduction in overlap while maintaining compliance with the regulatory interference threshold (e.g., -144 dBm/10MHz).

The optimization process performed by the R-ML generator 402 can consider multiple factors when selecting which CBSDs 106 to include in each move list. These factors can include, for example, the geographic proximity of CBSDs 106 to the DPA 100, real-time spectrum availability, and regulatory compliance thresholds. For the geographic proximity factor, the CBSDs 106 closer to the DPA 100 have a higher likelihood of impacting interference levels at the DPA protection points 108 and may be prioritized for potential shutdowns. For the real-time spectrum availability factor, the ICS 404 may continuously measure interference levels, and the R-ML generator 402 may adapt move list assignments based on current spectrum utilization conditions to avoid unnecessary CBSD shutdowns when interference risks are low. For the regulatory compliance threshold factor, the R-ML generator 402 can ensure that all move lists adhere to the regulatory interference threshold (e.g., -144 dBm/10MHz or other threshold as the case may be), preventing excessive aggregate interference at any of the DPA protection points 108.

The R-ML generator 402 may compute R-MLs 204 for different numbers of R-MLs used in the interference mitigation strategy. In configurations using two R-MLs, the R-ML generator 402 generates the R-MLs 204(1), 204(2) that alternate shutdown responsibilities across activations, reducing the impact on individual CBSDs 106. The optimization process executed by the R-ML generator 402 may involve balancing competing objectives, such as minimizing the number of CBSDs 106 that appear on multiple R-MLs 204 and minimizing the average number of CBSDs 106 that are required to shut down across DPA activations. The R-ML generator 402 may evaluate multiple possible move list configurations and select solutions that maintain compliance while distributing shutdown responsibilities across CBSDs 106 efficiently.

To enhance efficiency, the R-ML generator 402 operates in conjunction with the geolocation database 408. The geolocation database 408 provides DPA location data 410 and CBSD location data 412. The SAS 400 can use the DPA location data 410 and the CBSD location data 412 to allow for precise geographic optimizations of move lists. This integration ensures that CBSDs 106 are not arbitrarily shut down but rather selected based on interference impact and geographic proximity. Additionally, the control interface 406 may enable spectrum managers to adjust optimization parameters, which control the balance between fairness and spectrum efficiency while ensuring interference protection.

The R-ML generator 402 serves as the core decision-making engine within the SAS 400. The R-ML generator 402 computes move lists that improve both spectrum fairness and efficiency while ensuring incumbent protection.

The ICS 404 is a real-time spectrum assessment module within the SAS 400 that evaluates aggregate interference levels at the DPA protection points 108 within the DPA 100. The ICS 404 functions as an automated compliance mechanism to ensure that transmissions from the CBSDs 106 do not exceed the regulatory interference threshold (e.g., -144 dBm/10MHz) established to protect incumbent radar operations, such as the radar system 102.

To effectively monitor and regulate interference, the ICS 404 may integrate multiple data sources and processing techniques, including real-time CBSD activity tracking, radar beam directions, propagation modeling, and environmental impact assessments. By continuously analyzing these data inputs, the ICS 404 may detect potential interference violations and coordinate with other SAS subsystems, particularly the R-ML generator 402, to implement adaptive interference mitigation strategies.

The ICS 404 may collect real-time RF signal measurements from CBSD transmissions and model their impact at the DPA protection points 108. The ICS 404 may consider beam propagation characteristics of the radar system 102, terrain-based path loss effects using a propagation model such as the Irregular Terrain Model (ITM), and environmental conditions that may influence signal attenuation. The ICS 404 may perform dynamic power level assessments to determine whether CBSD emissions pose a risk of exceeding regulatory interference thresholds. The ICS 404 may aggregate interference levels at each DPA protection point 108 and each beam direction, considering transmissions from all active CBSDs 106 within a neighborhood of the DPA 100. This aggregated interference computation may account for signal contributions from multiple CBSDs 106 operating on the incumbent channel, transmission power levels, and antenna configurations. The ICS 404 compares the computed aggregate interference against the predefined threshold (e.g., -144 dBm/10MHz) to determine whether regulatory compliance is being maintained.

If the ICS 404 detects that interference at any DPA protection point 108 for any beam direction exceeds the regulatory threshold, the ICS 404 flags the violation and triggers an enforcement action by the SAS 400. This enforcement action may include issuing transmission modification commands to specific CBSDs 106 based on precomputed move lists (e.g., the M-ML 202, the S-ML 200, or the R-MLs 204). The ICS 404 may also communicate with the R-ML generator 402 to dynamically adjust move lists based on real-time interference trends. By integrating real-time measurements with historical interference data and predictive modeling, the ICS 404 can ensure that move list enforcement is both responsive and optimized.

The ICS 404 interfaces with the geolocation database 408, which stores DPA location data 410 and CBSD location data 412. The ICS 404 may consider the positions of CBSDs 106 relative to the DPA 100 and the DPA protection points 108 to identify the most relevant CBSDs 106 for shutdown. In this manner, the ICS 404 can minimize unnecessary spectrum access restrictions. The ICS 404 may dynamically support different R-ML configurations. By integrating directly with the R-ML generator 402, the ICS 404 ensures that move list assignments dynamically respond to real-time interference conditions.

Additionally, the ICS 404 provides real-time interference monitoring data to the control interface 406. This data allows operators to visualize interference trends, monitor compliance metrics, and review enforcement actions. The control interface 406 may provide graphical representations of interference levels across the DPA protection points 108. This enables SAS to make enforcement as needed. By integrating real-time interference monitoring, exceedance detection, transmission enforcement, and spatial optimization, the ICS 404 serves as the primary interference compliance mechanism within the SAS 400. The ICS 404 may continuously analyze interference contributions from the CBSDs 106, ensure regulatory compliance at the DPA protection points 108, and coordinate with the R-ML generator 402 to optimize shutdown assignments in a dynamic, data-driven manner.

The control interface 406 provides a user-facing platform for managing interference protection, move list deployment, and transmission enforcement. The control interface 406 serves as a centralized control and monitoring system that enables spectrum managers, regulatory authorities, and automated systems to configure, review, and adjust SAS operations in real time. The control interface 406 can facilitate both manual and automated decision-making.

The control interface 406 may provide real-time visualization and status monitoring of interference levels, protection point compliance, and CBSD shutdown status. The control interface 406 can integrate data from the ICS 404 to display interference levels at individual DPA protection points 108, such as in graphical and/or tabular formats. Spectrum managers can use the interference levels to assess whether CBSDs 106 are operating within the regulatory interference threshold. The control interface 406 can allow spectrum managers to configure system parameters and enforcement policies. Spectrum managers may adjust optimization parameters used by the R-ML generator 402, define DPA activation conditions, and modify interference threshold limits based on evolving spectrum requirements. The control interface 406 may also allow spectrum managers to enable or disable specific CBSDs 106 for testing, manually override move list assignments, or prioritize CBSDs 106 based on operational needs.

The control interface 406 may support comprehensive move list management, allowing spectrum managers to review, modify, and validate the contents of S-MLs (e.g., the S-ML 200) and R-MLs (e.g., the R-MLs 204(1) and 204(2)). The control interface 406 may provide a comparison of move list assignments across different R-ML configurations, displaying the number of CBSDs 106 affected by each list, the overlap reduction between successive activations, and historical shutdown patterns. This capability enables spectrum managers to assess fairness improvements achieved through the R-ML methodology.

For advanced troubleshooting and decision support, the control interface 406 can provide logging and audit functionalities for operators to review past interference events, analyze SAS enforcement actions, and generate compliance reports for regulatory submission. The control interface 406 can maintain detailed records of CBSD activations, move list assignments, interference levels at the DPA protection points 108, and system-generated enforcement actions.

Additionally, the control interface 406 can integrate with external regulatory and enforcement systems. In this manner, the SAS 400 can communicate with national spectrum databases, automated compliance verification platforms, and remote spectrum sensors. This interoperability allows for seamless regulatory compliance monitoring.

The control interface 406 may also include real-time event handling and automated response capabilities. If interference levels approach regulatory thresholds at any DPA protection point 108, the control interface 406 can automatically adjust move list enforcement parameters, dynamically triggering additional CBSD shutdowns. This ensures that the SAS 400 maintains compliance without requiring continuous human oversight.

The geolocation database 408 is configured to store and manage precise geospatial data related to the CBSDs 106 and the DPAs 100. In the illustrated example, the geolocation database 408 includes two datasets: the DPA location data 410 and the CBSD location data 412. The DPA location data 410 provides precise spatial boundaries and protection point locations for the DPA 100 and other DPAs (not shown), ensuring that interference calculations are conducted at the correct DPA protection points 108. The CBSD location data 412 contains accurate geographic coordinates of registered CBSDs 106, including latitude and longitude coordinates, altitude, and operational parameters, such as transmission power and antenna height. The CBSD location data 412 is used by the SAS 400 for determining which CBSDs 106 are within range of a DPA 100. The ICS 404 utilizes the DPA location data 410 to continuously monitor and evaluate interference levels at the DPA protection points 108 and to adjust move list enforcement dynamically based on real-time conditions.

By integrating the DPA location data 410 and the CBSD location data 412, the geolocation database 408 enables the SAS 400 to perform geographically optimized move list calculations, ensuring that CBSD shutdowns are targeted and efficient. This spatial optimization helps minimize unnecessary disruptions to CBSD operations while maintaining strict compliance with regulatory interference thresholds.

Additionally, the geolocation database 408 may support advanced interference modeling, incorporating terrain data, propagation characteristics, and environmental factors to refine interference impact predictions. By leveraging this high-precision location data, the SAS 400 can implement R-ML enforcement strategies to improve spectrum access fairness and to enhance the effectiveness of the R-ML methodology.

An incumbent detection system 414 detects when an incumbent user, such as the radar system 102, is active within the DPA 100. The incumbent detection system 414 may communicate with the SAS 400 to indicate when the DPA 100 should be activated, triggering the enforcement of move lists. In some implementations, the incumbent detection system 414 may be operated by another entity separate from the SAS 400.

A Federal Communications Commission (FCC) database 416 may store regulatory information, such as CBSD registration data, spectrum allocation records, and compliance requirements. The SAS 400 may communicate with the FCC database 416 to verify CBSD registrations, retrieve regulatory parameters, and report compliance status.

The CBSDs 106 are the secondary spectrum users, which can be categorized into categories such as Category A CBSDs 106(A) and Category B CBSDs 106(B). The CBSDs 106 operate under the oversight of the SAS 400, and when the DPA 100 is activated, specific CBSDs 106 are instructed to cease transmissions to prevent interference. The SAS 400 computes R-MLs (e.g., the R-MLs 204(1) and 204(2)) to determine which CBSDs 106 should be shut down. R-MLs dynamically rotate CBSD shutdowns across activations, reducing CBSD overlap in successive activations.

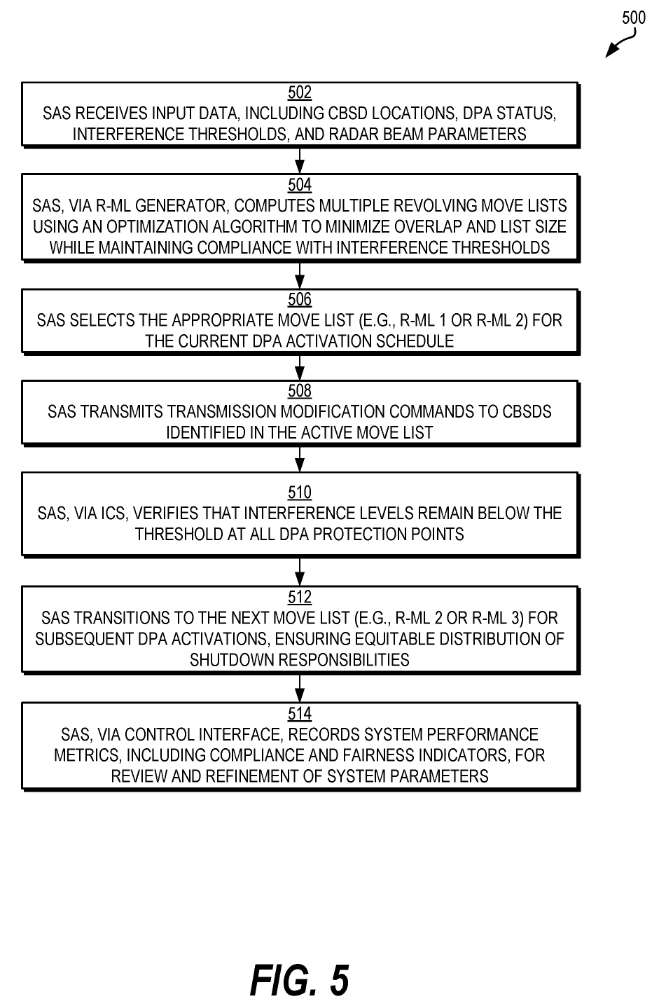

Turning to FIG. 5, shown is a flowchart of a method 500 for managing interference within a DPA using R-MLs according to an example implementation. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

At block 502, the SAS 400 receives input data, including CBSD locations, DPA status, interference thresholds, and radar beam parameters. The CBSD locations may be obtained from the CBSD location data 412 stored in the geolocation database 408. The DPA status may indicate whether the DPA 100 is active or inactive, and may be received from the incumbent detection system 414. The interference thresholds may include a regulatory interference threshold (e.g., -144 dBm/10MHz) that defines the maximum allowable aggregate interference at the DPA protection points 108. The radar beam parameters may include the azimuthal beamwidth 110 and the directional increments 112 associated with the radar system 102.

At block 504, the SAS 400, via the R-ML generator 402, computes multiple revolving move lists using an optimization algorithm to minimize overlap and list size while maintaining compliance with interference thresholds. The R-ML generator 402 may employ a multi-objective optimization algorithm to compute the R-MLs 204. The optimization algorithm may be designed to minimize the overlap of CBSDs 106 across different R-MLs (i.e., minimize the number of CBSDs 106 that appear on multiple R-MLs) while also minimizing the average size of each R-ML (i.e., minimize the average number of CBSDs 106 per R-ML). The R-ML generator 402 may rely on input from the geolocation database 408 to evaluate signal propagation data and potential interference contributions of each CBSD 106. The R-MLs 204 are computed such that, when any one of the R-MLs 204 is enforced in combination with the M-ML 202, the aggregate interference at each DPA protection point 108 across all beam directions remains below the regulatory interference threshold.

At block 506, the SAS 400 selects the appropriate move list (e.g., the first R-ML 204(1) or the second R-ML 204(2)) for the current DPA activation schedule. The SAS 400 may select among the precomputed R-MLs based on a rotation schedule, such that each successive DPA activation uses a different R-ML from the previous activation. For example, if the first R-ML 204(1) was applied during a first DPA activation, the SAS 400 may select the second R-ML 204(2) for a second DPA activation, and so forth in a circular sequence.

At block 508, the SAS 400 transmits transmission modification commands to CBSDs 106 identified in the active move list. The transmission modification commands may instruct the CBSDs 106 to cease transmission during the DPA activation period. In some implementations, the transmission modification commands may instruct the CBSDs 106 to reduce transmission power or modify other transmission parameters rather than ceasing transmission entirely. The CBSDs 106 identified in the active move list include the CBSDs 106 on the selected R-ML (e.g., the first R-ML 204(1) or the second R-ML 204(2)) and the CBSDs 106 on the M-ML 202.

At block 510, the SAS 400, via the ICS 404, verifies that interference levels remain below the threshold at the DPA protection points 108. The ICS 404 may evaluate aggregate interference at each DPA protection point 108 across all beam directions to confirm compliance with the regulatory interference threshold. If the interference at any DPA protection point 108 for any beam direction exceeds the regulatory threshold, the SAS 400 may iteratively adjust the move list or issue additional transmission modification commands to ensure compliance.

At block 512, the SAS 400 transitions to the next move list (e.g., the second R-ML 204(2) or a third R-ML 204(3)) for subsequent DPA activations, ensuring equitable distribution of shutdown responsibilities. The R-MLs 204 may be applied in a circular sequence, such that after all R-MLs 204 have been applied, the SAS 400 cycles back to the first R-ML 204(1). This rotation ensures that shutdown responsibilities are distributed across different CBSDs 106 over time, reducing the repeated burden on individual devices.

At block 514, the SAS 400, via the control interface 406, records system performance metrics, including compliance and fairness indicators, for review and refinement of system parameters. The performance metrics may include compliance rates indicating the percentage of DPA activations in which interference levels remained below the regulatory threshold, fairness indicators quantifying the distribution of shutdown responsibilities across CBSDs 106, and historical shutdown patterns identifying which CBSDs 106 have been shut down most frequently. These metrics may inform refinements to system parameters and future interference management strategies.

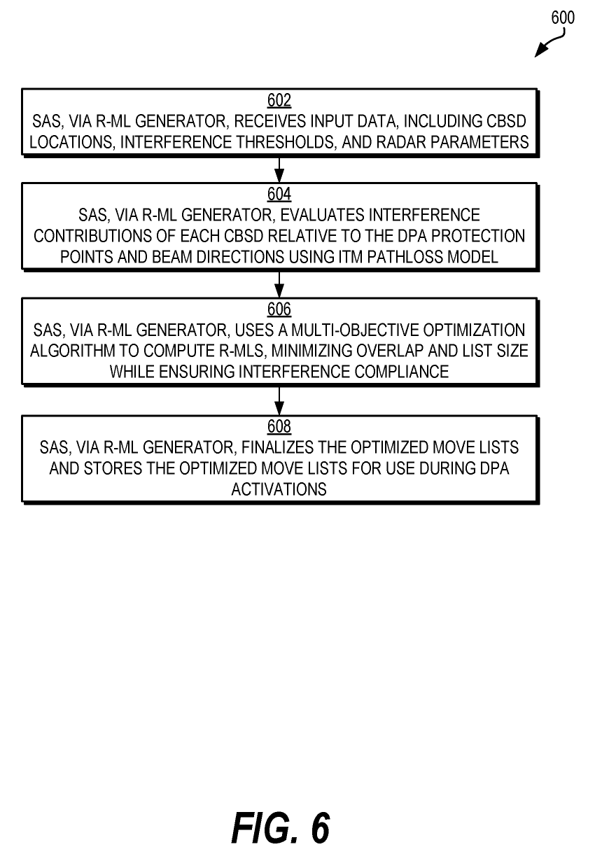

Turning to FIG. 6, shown is a flowchart of a method 600 for computing R-MLs 204 according to an example implementation. The method 600 may be performed by the R-ML generator 402 of the SAS 400 described with reference to FIG. 4. It should be understood that the operations of the method 600 are not necessarily presented in any particular order and that performance of some or all of the operations in an alternative order(s) is possible and is contemplated. Operations may be added, omitted, and/or performed simultaneously, without departing from the scope of the appended claims.

At block 602, the SAS 400, via the R-ML generator 402, receives input data, including CBSD locations, interference thresholds, and radar parameters. The CBSD locations may be obtained from the CBSD location data 412 stored in the geolocation database 408, and may include geographic coordinates (e.g., latitude, longitude, altitude) and operational parameters (e.g., transmission power, antenna height) for each registered CBSD 106 within a neighborhood of the DPA 100. The interference thresholds may include a regulatory interference threshold (e.g., -144 dBm/10MHz) that defines the maximum allowable aggregate interference at the DPA protection points 108. The radar parameters may include the azimuthal beamwidth 110, the directional increments 112, and the azimuth range associated with the radar system 102.

At block 604, the SAS 400, via the R-ML generator 402, evaluates interference contributions of each CBSD 106 relative to the DPA protection points 108 and beam directions using a propagation model, such as the Irregular Terrain Model (ITM) pathloss model. The R-ML generator 402 may compute the interference contribution of each CBSD 106 at each DPA protection point 108 for each beam direction based on the CBSD's transmission power, antenna characteristics, geographic location, and the pathloss between the CBSD 106 and the DPA protection point 108. The pathloss calculation may account for terrain data, propagation characteristics, and environmental factors. The interference contributions may be used to identify which CBSDs 106 have the greatest impact on aggregate interference at the DPA protection points 108, and to determine which CBSDs 106 should be included in the M-ML 202 (i.e., CBSDs that individually exceed the regulatory interference threshold) versus which CBSDs 106 are candidates for inclusion in the R-MLs 204.

At block 606, the SAS 400, via the R-ML generator 402, uses a multi-objective optimization algorithm to compute R-MLs, minimizing overlap and list size while ensuring interference compliance. The multi-objective optimization algorithm may balance two competing objectives: minimizing the overlap of CBSDs 106 across different R-MLs (i.e., minimizing the number of CBSDs 106 that appear on multiple R-MLs) and minimizing the average size of each R-ML (i.e., minimizing the average number of CBSDs 106 per R-ML). The optimization algorithm may be subject to a constraint that each R-ML, when enforced in combination with the M-ML 202, results in aggregate interference at each DPA protection point 108 across all beam directions remaining below the regulatory interference threshold. The multi-objective optimization algorithm may be implemented using mixed-integer linear programming, heuristic methods, or other known optimization techniques. In some implementations, the R-ML generator 402 may evaluate multiple possible move list configurations and select solutions that achieve a desired balance between overlap minimization and list size minimization while maintaining compliance.

At block 608, the SAS 400, via the R-ML generator 402, finalizes the optimized move lists and stores the optimized move lists for use during DPA activations. The R-MLs 204 may be stored in the geolocation database 408 or another storage location accessible to the SAS 400. The precomputed R-MLs 204 ensure dynamic and equitable management of CBSD shutdowns while maintaining compliance with interference thresholds. In some implementations, the R-ML generator 402 may periodically recompute the R-MLs 204 based on updated CBSD location data 412, changes in the regulatory interference threshold, or other changes in the operating environment.

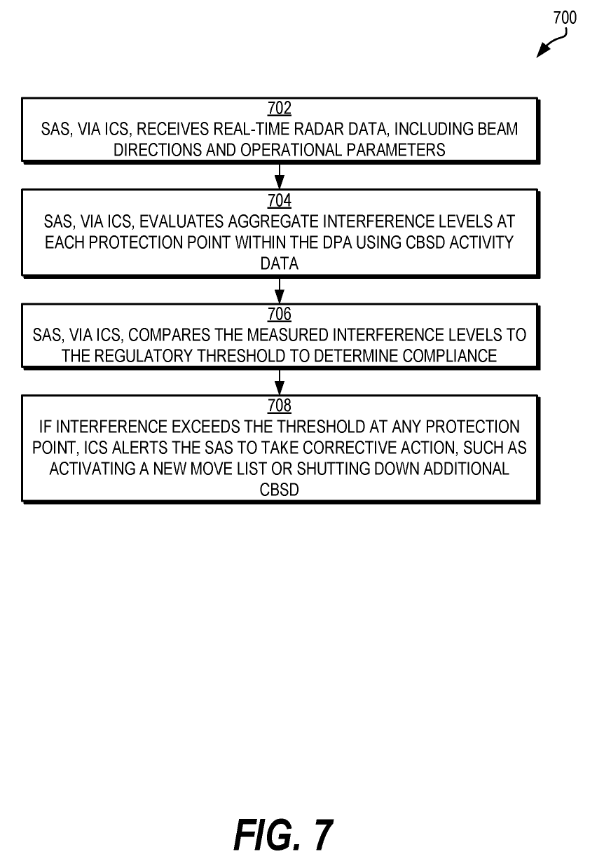

Turning to FIG. 7, shown is a flowchart of a method 700 for interference monitoring according to an example implementation. The method 700 may be performed by the ICS 404 of the SAS 400 described with reference to FIG. 4. It should be understood that the operations of the method 700 are not necessarily presented in any particular order and that performance of some or all of the operations in an alternative order(s) is possible and is contemplated. Operations may be added, omitted, and/or performed simultaneously, without departing from the scope of the appended claims.

At block 702, the SAS 400, via the ICS 404, receives real-time radar data, including beam directions and operational parameters. The beam directions may indicate the current orientation of the directional radar beam 104 emitted by the radar system 102. The operational parameters may include the azimuthal beamwidth 110, the directional increments 112, and the operational status of the radar system 102. In some implementations, the real-time radar data may be received from the incumbent detection system 414 or another source that monitors incumbent activity within the DPA 100.

At block 704, the SAS 400, via the ICS 404, evaluates aggregate interference levels at each protection point within the DPA 100 using CBSD activity data. The ICS 404 may collect real-time CBSD activity data indicating which CBSDs 106 are currently transmitting, their transmission power levels, and their operating frequencies. The ICS 404 may compute the aggregate interference at each DPA protection point 108 by summing the interference contributions from all active CBSDs 106 within the neighborhood of the DPA 100. The interference contributions may be computed based on transmission power, antenna characteristics, and pathloss between each CBSD 106 and the DPA protection point 108. The ICS 404 may evaluate aggregate interference across all beam directions at each DPA protection point 108, or may focus on specific beam directions based on the current orientation of the radar system 102.

At block 706, the SAS 400, via the ICS 404, compares the measured interference levels to the regulatory threshold to determine compliance. The regulatory threshold may be a predefined interference limit (e.g., -144 dBm/10MHz) established to protect incumbent operations. The ICS 404 may compare the computed aggregate interference at each DPA protection point 108 for each beam direction against the regulatory threshold. If the aggregate interference at all DPA protection points 108 across all beam directions remains below the regulatory threshold, the ICS 404 may determine that the current configuration is compliant and maintain the current move list enforcement.

At block 708, if interference exceeds the threshold at any protection point, the SAS 400, via the ICS 404, initiates corrective action, such as activating a new move list or shutting down additional CBSDs. If the ICS 404 detects that aggregate interference at any DPA protection point 108 for any beam direction exceeds the regulatory threshold, the ICS 404 may trigger an alert to the SAS 400 to enforce additional actions. The corrective actions may include activating a different R-ML from the precomputed R-MLs 204, issuing transmission modification commands to additional CBSDs 106 beyond those on the currently active move list, or adjusting transmission parameters (e.g., reducing transmission power) for specific CBSDs 106. This iterative feedback loop ensures real-time compliance with interference protection requirements and enables adaptive enforcement rather than relying solely on precomputed static configurations.

The features, structures, or characteristics described above may be combined in one or more implementations in any suitable manner, and the features discussed in the various implementations are interchangeable, if possible. In the following description, numerous specific details are provided in order to fully understand the implementations of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

What is claimed is:

1. A spectrum access system (SAS) comprising:
at least one processor; and
memory storing instructions that, when executed by the at least one processor, cause the SAS to at least:
receive location data of a plurality of citizens broadband radio service devices (CBSDs) and location data of a plurality of dynamic protection area (DPA) protection points associated with a DPA;
generate a plurality of revolving move lists (R-MLs) based on the location data, each R-ML identifying a subset of the plurality CBSDs that cease transmission when a radar system is active within the DPA, wherein the plurality of R-MLs are generated to minimize overlap among the plurality of CBSDs across the plurality of R-MLs while maintaining aggregate interference at each DPA protection point of the plurality of DPA protection points below a regulatory interference threshold;
monitor aggregate interference levels at each DPA protection point of the plurality of DPA protection points;
compare the aggregate interference levels against the regulatory interference threshold; and
transmit transmission modification commands to the subset of the plurality of CBSDs identified in a selected R-ML responsive to detecting that the radar system is active within the DPA.

2. The SAS of claim 1, wherein the plurality of R-MLs are further generated to minimize an average number of CBSDs per R-ML.

3. The SAS of claim 1, wherein the instructions, when executed, further cause the SAS to select the subset of the plurality of the CBSDs for inclusion in each R-ML based on signal propagation characteristics between each CBSD of the plurality of CBSDs and the plurality of DPA protection points.

4. The SAS of claim 1, wherein the instructions, when executed, further cause the SAS to apply different R-MLs from the plurality of R-MLs across successive activations of the radar system.

5. The SAS of claim 1, wherein the instructions, when executed, further cause the SAS to generate a must move list (M-ML) identifying a second subset of the plurality of CBSDs that cease transmission during every activation of the radar system, wherein each CBSD of the second subset individually produces interference at one or more DPA protection points of the plurality of DPA protection points exceeding the regulatory interference threshold.

6. The SAS of claim 1, wherein the instructions, when executed, further cause the SAS to evaluate aggregate interference at each DPA protection point of the plurality of DPA protection points across a plurality of beam directions associated with a directional radar beam emitted by the radar system.

7. The SAS of claim 1, wherein the instructions, when executed, further cause the SAS to verify that the aggregate interference levels at the plurality of DPA protection points remain below the regulatory interference threshold following transmission of the transmission modification commands.

8. A method comprising:
receiving, by a spectrum access system (SAS), location data of a plurality of citizens broadband radio service devices (CBSDs) and location data of a plurality of dynamic protection area (DPA) protection points associated with a DPA;
generating, by the SAS, a plurality of revolving move lists (R-MLs) based on the location data, each R-ML identifying a subset of the plurality of the CBSDs that cease transmission when a radar system is active within the DPA, wherein the plurality of R-MLs are generated to minimize overlap among the plurality of CBSDs across the plurality of R-MLs while maintaining aggregate interference at each DPA protection point of the plurality of DPA protection points below a regulatory interference threshold;
monitoring, by the SAS, aggregate interference levels at each DPA protection point of the plurality of DPA protection points;
comparing, by the SAS, the aggregate interference levels against the regulatory interference threshold; and
transmitting, by the SAS, transmission modification commands to the subset of the plurality of the CBSDs identified in a selected R-ML responsive to detecting that the radar system is active within the DPA.

9. The method of claim 8, wherein the plurality of R-MLs are further generated to minimize an average number of CBSDs per R-ML.

10. The method of claim 8, further comprising selecting, by the SAS, the subset of the plurality of the CBSDs for inclusion in each R-ML based on signal propagation characteristics between each CBSD of the plurality of CBSDs and the plurality of DPA protection points.

11. The method of claim 8, further comprising applying, by the SAS, different R-MLs from the plurality of R-MLs across successive activations of the radar system.

12. The method of claim 8, further comprising generating, by the SAS, a must move list (M-ML) identifying a second subset of the plurality of CBSDs that cease transmission during every activation of the radar system, wherein each CBSD of the second subset individually produces interference at one or more DPA protection points of the plurality of DPA protection points exceeding the regulatory interference threshold.

13. The method of claim 8, further comprising evaluating, by the SAS, aggregate interference at each DPA protection point of the plurality of DPA protection points across a plurality of beam directions associated with a directional radar beam emitted by the radar system.

14. The method of claim 8, further comprising verifying, by the SAS, that the aggregate interference levels at the plurality of DPA protection points remain below the regulatory interference threshold following transmitting the transmission modification commands.

15. A non-transitory computer-readable medium storing instructions that, when executed by at least one processor of a spectrum access system (SAS), cause the SAS to at least:
receive location data of a plurality of citizens broadband radio service devices (CBSDs) and location data of a plurality of dynamic protection area (DPA) protection points associated with a DPA;
generate a plurality of revolving move lists (R-MLs) based on the location data, each R-ML identifying a subset of the plurality of the CBSDs that cease transmission when a radar system is active within the DPA, wherein the plurality of R-MLs are generated to minimize overlap among the plurality of CBSDs across the plurality of R-MLs while maintaining aggregate interference at each DPA protection point of the plurality of DPA protection points below a regulatory interference threshold;
monitor aggregate interference levels at each DPA protection point of the plurality of DPA protection points;
compare the aggregate interference levels against the regulatory interference threshold; and
transmit transmission modification commands to the subset of the plurality of the CBSDs identified in a selected R-ML responsive to detecting that the radar system is active within the DPA.

16. The non-transitory computer-readable medium of claim 15, wherein the plurality of R-MLs are further generated to minimize an average number of CBSDs per R-ML.

17. The non-transitory computer-readable medium of claim 15, wherein the instructions, when executed, further cause the SAS to select the subset of the plurality of the CBSDs for inclusion in each R-ML based on signal propagation characteristics between each CBSD of the plurality of CBSDs and the plurality of DPA protection points.

18. The non-transitory computer-readable medium of claim 15, wherein the instructions, when executed, further cause the SAS to apply different R-MLs from the plurality of R-MLs across successive activations of the radar system.

19. The non-transitory computer-readable medium of claim 15, wherein the instructions, when executed, further cause the SAS to generate a must move list (M-ML) identifying a second subset of the plurality of CBSDs that cease transmission during every activation of the radar system, wherein each CBSD of the second subset individually produces interference at one or more DPA protection points of the plurality of DPA protection points exceeding the regulatory interference threshold.

20. The non-transitory computer-readable medium of claim 15, wherein the instructions, when executed, further cause the SAS to evaluate aggregate interference at each DPA protection point of the plurality of DPA protection points across a plurality of beam directions associated with a directional radar beam emitted by the radar system.
